(19) United States
(12) Patent Application Publication
(10) Pub. No.: US 2004/0223484 A1
(43) Pub. Date: Nov. 11, 2004

(54) Synchronization and interference measurement for mesh network

(76) Inventors: Ying Xia, San Jose, CA (US); Kamlesh Rath, San Ramon, CA (US)

Correspondence Address: GLENN PATENT GROUP, 3475 EDISON WAY, SUITE L, MENLO PARK, CA, 94025, US

(21) Appl. No.: 10/431,139

(22) Filed: May 6, 2003

(51) Int. Cl. H04J 3/06

(52) U.S. Cl. 370/350

(57) ABSTRACT

The invention comprises a sub-system that enables different network elements in a mesh network to synchronize with each other and to measure potential interfering links in the network. Link synchronization includes clock synchronization and network timing synchronization.

### BACKGROUND OF THE INVENTION

1. Technical Field

The invention relates to communications networks. More particularly, the invention relates to a method and apparatus for synchronization and interference measurement for a mesh network.

2. Description of the Prior Art

Point-multipoint (P-MP) systems are by far the most common network architecture used in broadband wireless Internet access. In such systems, a base station is established in a location visible to a number of customers. A backhaul connection is established to the base station via wireless or wireline, and customer premise equipment (CPE) is installed at each customer's location. In such installations, it is usually necessary to use an outdoor antenna to achieve reasonable range and performance.

One major drawback of P-MP is that base stations must be located where it is possible to site a base station, i.e. where proper orientation, infrastructure, and permission is available. However, such a location may not coincide with a target customer base. Base stations are also expensive, and the cost of backhaul services can be prohibitive.

Another major drawback to P-MP is that the cost of the CPE installations, i.e. the truck roll, becomes prohibitive in the aggregate as more and more customers are added to the system.

Yet another drawback to P-MP is that there are inevitably dead zones where some potential customers do not have line of sight (LOS) to the base station, and therefore cannot receive service.

Mesh networking generally dispenses with the idea of a base station, with each CPE also comprising a relay node. The backhaul connection is connected to one or more relay nodes, and each additional customer adds an additional relay node to the network.

Further, a mesh network requires all the links in the network to be synchronized to a common timing reference, i.e. all the time-slots/frames for the different links must start and end at the same actual time. Each link also requires clock synchronization, which translates into frequency, phase, and timing synchronization of the transmitter and receiver on the link.

This is also different in a mesh network because a CPE must synchronize with several other CPEs in the network instead of just the base-station in a point-to-multipoint network. Therefore, the synchronization reference node is not always the base station. The flow of synchronization in the network is performed in a staged manner first with the CPEs directly connected to the base-station. Then, the CPEs connected to the first set of CPEs are synchronized and so on until the whole network is synchronized. This way, each CPE synchronizes with its parent and serves as a synchronization reference for all its children.

It would be advantageous to provide a technique in which potential interference between links in a mesh network is readily determined, as well as the connectivity within the mesh network.

### SUMMARY OF THE INVENTION

Potential interference between links in a mesh network is determined using accurate link quality measurements. Link quality measurements are also used to determine the connectivity with in the mesh network.

### BRIEF DESCRIPTION OF THE DRAWINGS

FIG. 1 is a block diagram which shows an initial synchronization burst (ISB) format;

FIG. 2 is a timing diagram which shows a network timing synchronization scheme using ISB according to the invention; and

FIG. 3 is a block schematic diagram which shows an ISB detection algorithm according to the invention.

### DETAILED DESCRIPTION OF THE INVENTION

Potential interference between links in a mesh network is determined using accurate link quality measurements. Link quality measurements are also used to determine the connectivity within the mesh network.

The initial synchronization burst (ISB) is used to perform synchronization and interference measurement. Synchronization includes two functions: clock synchronization, and network timing synchronization. Clock synchronization compensates for the clock drift between the reference node and synchronization node. Network timing synchronization compensates for the propagation delay between the reference node and synchronization node. The accuracy of network timing synchronization should be within 500 ns.

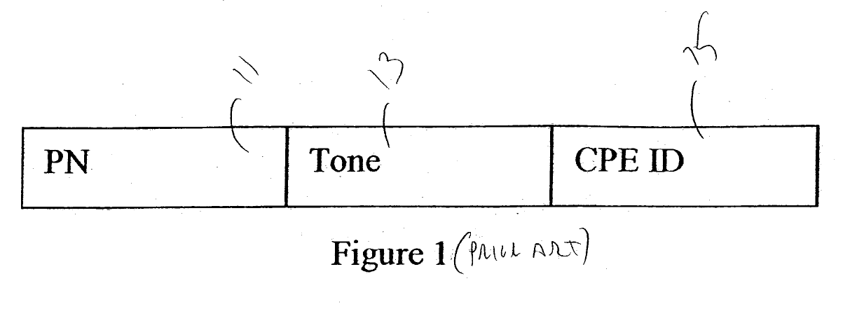

The ISB format is shown in FIG. 1. The PN part 11 is used for networking timing synchronization and the tone part 13 is used for clock synchronization. The CPE ID part 15 contains the transmitter source ID.

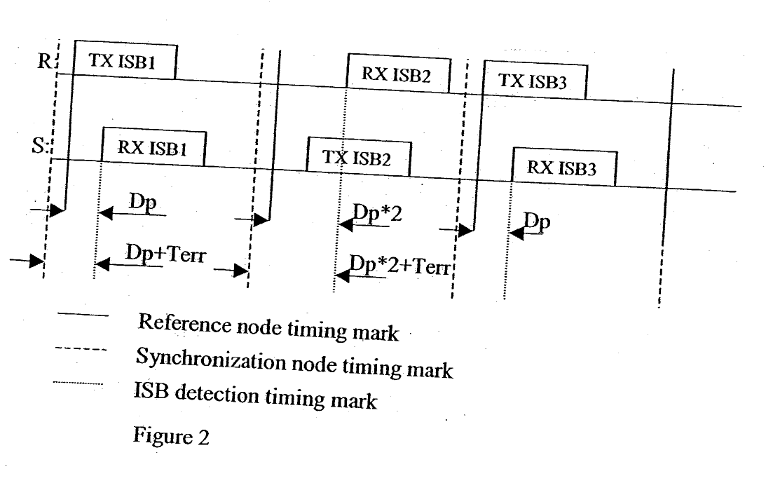

The network timing synchronization scheme using ISB is shown in FIG. 2, in which R is the reference node and S is the synchronization node. The timing error between R and S is Terr. During the ISB1 stage, node S detects ISB1. ISB2 is transmitted from node S based on the ISB1 detection time. When R receives ISB2, it calculates the propagation delay Dp. Dp is encoded into the ISB CPE ID part and transmitted to S again. This is ISB3. When S receives ISB3, it decodes the Dp. Then, S can adjust its timing mark based on Dp. The R node and S node then can be timing synchronized.

The network timing synchronization uses the ISB PN sequence as shown in Table 1 below. In the preferred embodiment, the PN sequence length is chosen to be 255 to give enough correlation gain for the additive white Gaussian noise (AWGN) channel and multi-path channels.

TABLE 1
PN sequence generator polynomial and initial states

| Polynomial | 1 + X + X2 + X7 + X8 |
|---|---|
| Initial state | 11111111 |

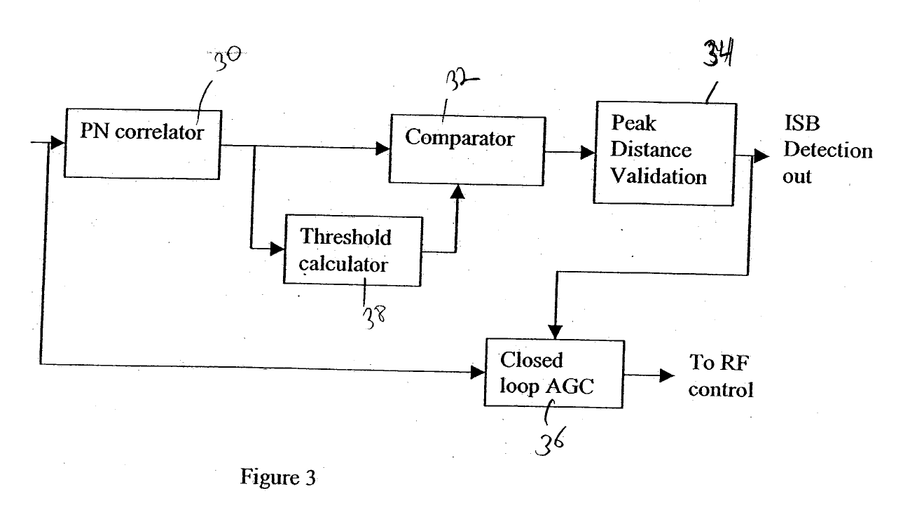

FIG. 3 shows the presently preferred ISB detection algorithm. Because network timing synchronization reliability depends on the ISB PN detection probability, two peak detections are used to make sure that the peak is valid before claiming that ISB detection has occurred. The PN sequence is duplicated twice to generate two peaks at the correlator 30. Then, the correlator output is compared with the correlation noise floor, as determined by a threshold calculator 38, at a comparator 32 to make sure that it is high enough to claim as a peak. If true, the distance of two peaks is checked by a peak distance validation module 34 to make sure that it is valid. Using this method reduces the probability of a detection false alarm.

The interference measurement uses ISB detection results. On detection of the ISB PN code, the correlator output and the automatic gain control (AGC) 36 output are stored. Although the AGC output could indicate the received signal strength, it can give false readings due to adjacent channel noise, especially when the desired channel signal-to-noise ratio (SNR) is low. On the other hand, the correlator output also indicates the received signal quality, but when the received SNR is very high, the correlator output can become saturated.

To avoid the drawback of these two separate measurements, a combined scheme using both correlator peak and AGC output is designed which gives a very accurate interference measurement. When the peak is less than the correlation saturation level, the peak value is used to indicate the interference. Otherwise, the AGC output is used. Based on this measurement, the link can get a very accurate indication of the level of interference. This indication can be used to determine if the level of interference at the receiver allows it to receive any type of modulated signal (64QAM, 16QAM or QPSK), or if it cannot decode any signal along with the interfering source.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method for determining potential interference between links in a mesh network and for determining connectivity within said mesh network using accurate link quality measurements, comprising the steps of:
providing a pilot signal (initial synchronization burst (ISB); and
performing a synchronization and interference measurement based upon said pilot signal.

2. The method of claim 1, wherein synchronization comprises any of clock synchronization and network timing synchronization.

3. The method of claim 2, further comprising the step of:
performing clock synchronization to compensate for clock drift between a reference node and a synchronization node.

4. The method of claim 2, further comprising the step of:
performing network timing synchronization to compensate for propagation delay between a reference node and a synchronization node.

5. The method of claim 1, wherein said ISB format comprises a PN part for networking timing synchronization, a tone part for clock synchronization, and a CPE ID part for transmitter source ID.

6. A network timing synchronization method for a mesh network that comprises at least one reference node R and at least one synchronization node S, the method comprising the steps of:
determining a timing error Terr between R and S;
during an initial synchronization burst (ISB) stage ISB1, node S detecting ISB1;
transmitting a second ISB, ISB2, from node S based on an ISB1 detection time;
when R receives ISB2, R calculating a propagation delay Dp;
R encoding Dp into an ISB CPE ID part;
R transmitting a third ISB, ISB3, to S; and
when S receives ISB3, S decoding Dp;
wherein S can adjust its timing mark based on Dp; and
wherein said R node and said S node are timing synchronized.

7. An initial synchronization burst (ISB) detection method for reducing a probability of a detection false alarm, comprising the steps of:
using at least two peak detections to make sure that a peak is valid before claiming that ISB detection has occurred;
duplicating a PN sequence twice to generate two peaks at a correlator;
comparing said correlator output with a correlation noise floor, as determined by a threshold calculator, at a comparator to determine if it is high enough to claim as a peak; and
if true, checking a distance of two peaks by a peak distance validation module to determine if it is valid.

8. An interference measurement method for a mesh network, comprising the steps of:
detecting an initial synchronization burst (ISB);
on detection of an ISB PN code, storing a correlator output and an automatic gain control (AGC) output;
when a detected peak is less than a correlation saturation level, using said peak value to indicate interference;
otherwise, using AGC output to indicate interference;
wherein a link is provided with an accurate indication of a level of interference.

9. The method of claim 8, further comprising the step of:
using said indication to determine if a level of interference at a receiver allows said receiver to receive any type of modulated signal, or if said receiver cannot decode any signal along with an interfering source.
